(19) United States
(12) Patent Application Publication
(10) Pub. No.: US 2022/0180332 A1
(43) Pub. Date: Jun. 9, 2022

(54) CRYPTOCURRENCY MANAGEMENT SYSTEM FOR BUSINESS USE

(71) Applicant: SecuX Technology Inc., Hsinchu City (TW)

(72) Inventors: Hung-Yi CHENG, Hsinchu City (TW); Wei An CHEN, Hsinchu City (TW)

(21) Appl. No.: 17/509,620

(22) Filed: Oct. 25, 2021

(30) Foreign Application Priority Data
Dec. 3, 2020 (TW) 109142695

(51) Int. Cl. G06Q 20/06; G06Q 20/32

(52) U.S. Cl. CPC G06Q 20/065; G06Q 20/3278; G06Q 20/3276

(57) ABSTRACT

A cryptocurrency management system is applied for business use. In the management system, a business management terminal device executes a CKD function calculation according to a master seed key to generate a plurality of management-end child keys. A cloud management sub-system executes the CKD function calculation according to each of the management-end child keys to generate a plurality of payment-receiving child keys. Each of payment-receiving terminal devices is applied to generate a payment barcode according to a device ID code thereof and one of the payment-receiving child keys corresponding to the kind of cryptocurrency that a client intends to pay for a consumption transaction, so as to provide a payment means for the client by using a mobile payment device to link a blockchain to pay the kind of cryptocurrency after scanning the payment barcode.

This application claims the benefit of Taiwan Patent Application Serial No. 109142695, filed Dec. 3, 2020, the subject matter of which is incorporated herein by reference.

### BACKGROUND OF THE INVENTION

### (1) Field of the Invention

The invention relates to a management system, and more particularly to a cryptocurrency management system for business use that can be used to manage a plurality cryptocurrencies.

### (2) Description of the Prior Art

Due to rising environmental awareness and changes in shopping patterns, use of physical currencies for payments has been gradually reduced. In addition, after receiving physical currencies paid by clients, significant labor costs and custody risks would be inevitable to the business for subsequent counting and keeping.

In need of a more convenient transaction protocol between the client and the business toward consumption or even liquidation of business income, the electronic payment has been introduced and becomes more and more popular. In electronic payment, the physical currency is still used as the unit for valuation, and various electronic vouchers are used for payment. However, since most of personal data (especially identity verification data), payment calculation data, clearing data and account data are stored and processed in the cloud server, possibility of data hacking, being thieved or manipulated is relatively high while mobile communication devices are used to communicate with the cloud server for data verification and transmission. In addition, since current electronic payments still rely on system resources provided by financial institutions or system managers, thus part of the payment would be directly deducted as the transaction fee for each transaction, and, from which, additional cost is inevitable to the business.

In order not to have most of transaction data to be stored in the cloud server, which may lead to the risk of transaction record being stolen or tampered, new transaction methods of using cryptocurrencies for payment are developed. In one of the cryptocurrency transaction methods, a blockchain technology utilizing discrete computer nodes for verification and value transmission has successfully decentralized the aforesaid business payment model of centralized issuance and verification.

However, since cryptocurrencies are various, cryptocurrency transactions must be recorded in separate cryptocurrency blockchains (such as BTC blockchain, ETH blockchain or LTC blockchain), and transaction data recorded in individual cryptocurrency blockchains cannot be directly exchanged with each other, thus it is necessary to construct different payment-collected sale modules for receiving corresponding cryptocurrencies in the same payment-receiving terminal device. Definitely, a high expense in setting up the payment-receiving terminal device can be expected. As a matter of fact and so far, the technology of using cryptocurrencies to conduct transactions is not suitable for every payment-collected sale at any physical business site.

On the other hand, since different cryptocurrencies would be collected and recorded through different cryptocurrency blockchains, it is not easy to integrate all transaction records while in the liquidation of business income, and also not easy to process statistical analysis. Namely, cryptocurrency collection status of each business site can't be clearly understood to the business.

### SUMMARY OF THE INVENTION

In view that the prior payment technology exists problems in safety of preventing personal data from being stolen, transaction fee losses, setup costs of payment-receiving terminal devices, and difficulty to liquidate business income, accordingly it is an object of the present invention to provide a cryptocurrency management system for business use, which is configured for a business to manage L kinds of cryptocurrencies, and for a client to utilize a mobile payment device to consume at more than one business site of the business by paying at least one of the aforesaid L kinds of cryptocurrencies. In particular, the mobile payment device is furnished with at least one electronic wallet for at least one of the L kinds of cryptocurrencies.

A cryptocurrency management system for business use includes a hardware wallet for business use, a business management terminal device, a cloud management sub-system and M payment-receiving terminal devices. The hardware wallet for business use is used to store a master seed key. The business management terminal device, connected signally with the hardware wallet for business use via a short-range communication means, is configured to receive the master seed key, to further perform a CKD (Child key derivation) function calculation according to the master seed key for deriving L different management-end child keys to realize cryptocurrency account addresses for the L different management-end child keys corresponding to the L kinds of cryptocurrencies, and to perform the CKD function calculation for generating L×M different payment-receiving child keys according to each of the L different management-end child keys. Each of the L kinds of cryptocurrencies has M different payment-receiving child keys.

The cloud management sub-system is connected signally with the business management terminal device, and also connected signally with L cryptocurrency blockchains corresponding to the L kinds of cryptocurrencies. The M payment-receiving terminal devices are disposed at the at least one business site, and connected signally with the business management terminal device.

Each of the M payment-receiving terminal devices has a device ID code. Each of the M payment-receiving terminal devices receives one of the M payment-receiving child keys corresponding to each of the L kinds of cryptocurrencies from the business management terminal device so as totally to receive L of the M payment-receiving child keys corresponding to the L kinds of cryptocurrencies. Each of the payment-receiving terminal devices further evaluates the device ID code and the payment-receiving child key corresponding to the cryptocurrency to be paid out of the L kinds of the cryptocurrencies while the client consumes to generate a payment barcode for the mobile payment device to scan with respect to the device ID code and the cryptocurrency to be paid.

After the client utilizes the mobile payment device to scan the payment barcode, the cloud management sub-system is connected with the cryptocurrency blockchain corresponding to the cryptocurrency to be paid of the client, and then the cryptocurrency to be paid is paid to the cryptocurrency account address corresponding to the cryptocurrency to be paid.

In one embodiment of the present invention, the cloud management sub-system can include a cloud payment management server and a blockchain integrator. The cloud payment management server is connected signally with the mobile payment device and the business management terminal device. After the client utilizes the mobile payment device to scan the payment barcode, the cloud management sub-system transmits a payment-request signal.

Upon receiving the payment-request signal, the blockchain integrator connected signally with the cloud payment management server connects the cryptocurrency blockchain corresponding to the cryptocurrency to be paid of the client. Further, after the cryptocurrency blockchain completes a sale-payment record, a sale-confirmed signal is transmitted back to the cloud payment management server.

Preferably, the blockchain integrator includes L blockchain-connected nodes and a cloud API. The blockchain-connected nodes are configured to connect individually the L cryptocurrency blockchains. The cloud API, electrically connected with the L blockchain-connected nodes, transmits the sale-confirmed signal upon when the sale-payment record is complete.

Preferably, in order for the user or operator of the cryptocurrency management system for business use can confirm whether or not a payment-collected sale has been completed, the cloud payment management server further includes a payment-receiving confirmation module connected signally with the cloud API, and the payment-receiving confirmation module transmits a payment-receiving confirmed signal to the business management terminal device after the sale-confirmed signal is received. Thereupon, the user or operator of the business management terminal device can confirm whether or not the payment-collected sale has been completed.

Further preferably, in order to further facilitate the clearing and statistics of the payment-receiving amounts of each kind of the cryptocurrencies collected by each of the payment-receiving terminal devices, the business management terminal device further includes a terminal-device management module connected signally with the payment-receiving confirmation module and the M payment-receiving terminal devices, the terminal-device management module is configured to transmit the payment-receiving confirmed signal to the payment-receiving terminal device corresponding to the device ID code, and to record the device ID code and a corresponding payment-receiving amount of the payment-receiving terminal device with respect to the cryptocurrency to be paid.

The business management terminal device includes a CKD function computation module configured for performing the CKD function calculation to derive the L different management-end child keys for realizing the L cryptocurrency account addresses. The short-range communication means is one of a Bluetooth communication means and a near-field communication (NFC) means. Each of the M payment-receiving terminal devices further includes a barcode generator and a barcode display. The barcode generator is configured for generating the payment barcode. The barcode display, electrically connected with the barcode generator, is configured for displaying the payment barcode.

As stated, in the cryptocurrency management system for business use provided by this invention, the CKD function calculation of the hierarchical deterministic technique, the cloud management technique and the discrete blockchain record technique are integrated. Through the one-way deduction of decryption characteristics in the CKD function calculation of the hierarchical deterministic technique, collection of different cryptocurrencies (such as Bitcoin, Ethereum and Litecoin) can be feasible, and thus the security of decryption and the diversity of payment kinds can be effectively obtained. Through recording the transactions discretely to respective cryptocurrency blockchains (such as the BTC blockchain, the ETH blockchain and the LTC blockchain), then the possibility of data tampering would be significantly reduced, and thus the clarity of transaction records can be greatly improved. In addition, through the cloud management technique to record the device ID codes and the corresponding payment-receiving amounts at the payment-receiving terminal device, the convenience in business income liquidation and management statistics can be obtained. Obviously, with this invention, the security of decryption can be upgraded, the diversity of payment kinds can be further expanded, the clarity of transaction records can be improved, and the convenience of business income liquidation and management statistics can be obtained. Namely, this invention has proved to provide remarkable improvements in different manifolds.

All these objects are achieved by the cryptocurrency management system for business use described below.

### BRIEF DESCRIPTION OF THE DRAWINGS

The present invention will now be specified with reference to its preferred embodiment illustrated in the drawings, in which:

FIG. 1 is a schematic block view of a preferred embodiment of the cryptocurrency management system for business use in accordance with the present invention;

FIG. 2 is a schematic block view of the cloud management sub-system of FIG. 1;

FIG. 3 is a schematic functional block view showing a first usage scenario of the preferred embodiment of FIG. 1; and

FIG. 4 is a schematic functional block view showing a second usage scenario of the preferred embodiment of FIG. 1.

### DESCRIPTION OF THE PREFERRED EMBODIMENT

The invention disclosed herein is directed to a cryptocurrency management system for business use. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

According to this invention, the cryptocurrency management system for business use can be widely applied to various business for managing simultaneously a plurality of cryptocurrencies. Since various embodiments thereof can be provided, thus, in order to omit repeated details common to these embodiments, only the preferred embodiment there-among is particularly raised for elucidating the present invention.

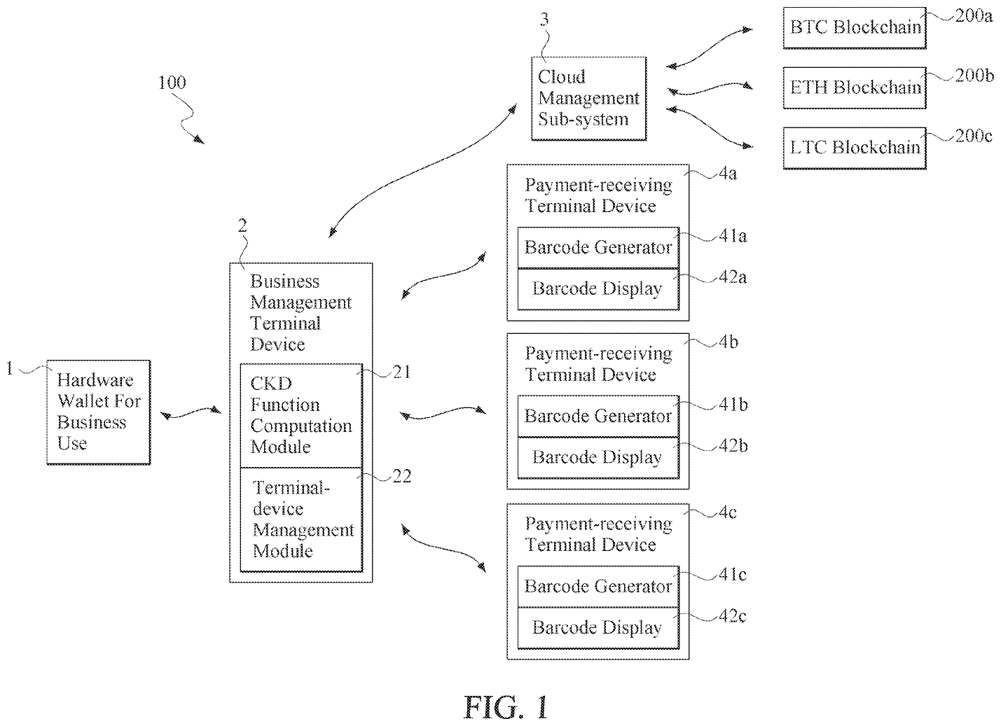

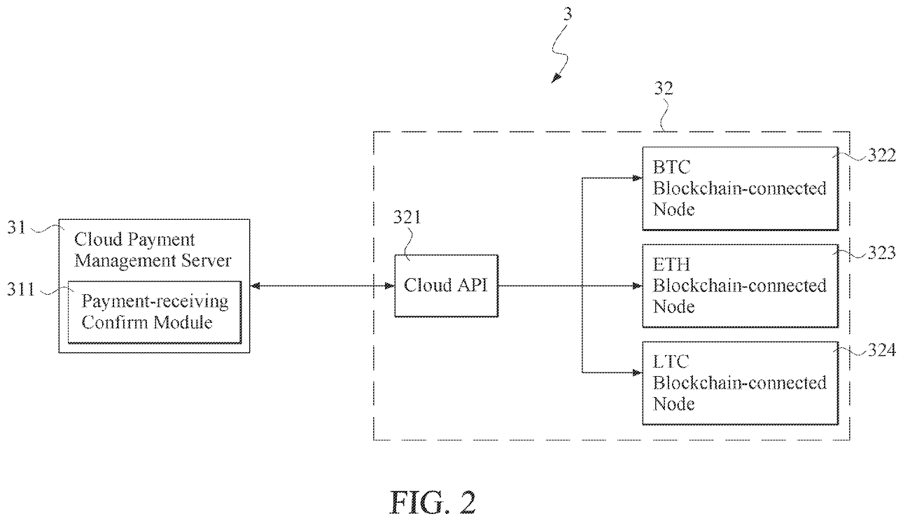

Refer to FIG. 1 and FIG. 2; where FIG. 1 is a schematic block view of a preferred embodiment of the cryptocurrency management system for business use in accordance with the present invention, and FIG. 2 is a schematic block view of the cloud management sub-system of FIG. 1. As shown, in this embodiment, the cryptocurrency management system for business use (the cryptocurrency management system, hereinafter) 100 is configured for a business to manage L kinds of cryptocurrencies simultaneously. In this embodiment, three kinds of cryptocurrencies, such as Bitcoin, Ethereum and Litecoin, are included. Namely, in this embodiment, L is equal to 3.

The cryptocurrency management system 100 includes a hardware wallet for business use 1, a business management terminal device 2, a cloud management sub-system 3 and M payment-receiving terminal devices. In this embodiment, the cryptocurrency management system 100 includes three payment-receiving terminal devices 4a, 4b and 4c; i.e., M=3.

The hardware wallet for business use 1 is configured to store a master seed key. The business management terminal device 2 includes a CKD (Child key derivation) function computation module 21 and a terminal-device management module 22 connected signally with the hardware wallet for business use 1 via a short-range communication means. In this embodiment, the short-range communication means can be a Bluetooth communication means or a near-field communication (NFC) means.

The business management terminal device 2 can be used to receive the master seed key, and the CKD function computation module 21 would evaluate the master seed key to perform a CKD (Child key derivation) function calculation so as to obtain L management-end child keys. These L management-end child keys are different to each other, and used for realizing L cryptocurrency account addresses corresponding to the L kinds of cryptocurrencies. In this embodiment, the master seed key is used to realize 3 different management-end child keys. These three different management-end child keys are used to analyze a Bitcoin account address, an Ethereum account address and a Litecoin account address corresponding to Bitcoin, Ethereum and Litecoin in a BTC blockchain 200a, an ETH blockchain 200b and a LTC blockchain 200c, respectively. It shall be emphasized that the cryptocurrencies available currently may be various, evenly more than dozens. Thus, while in configuring the cryptocurrency management system 100, the number of cryptocurrency kinds to be managed (i.e., L) can be determined according to the liquidity, popularity or other factors of individual cryptocurrencies.

The CKD function computation module 21 would evaluate the number (i.e., M in this embodiment) of the payment-receiving terminal devices to perform the corresponding CKD function calculation upon each of the management-end child keys so as to generate L×M different payment-receiving child keys, in which each individual cryptocurrency would have M different payment-receiving child keys. In this embodiment, by having the Bitcoin as an example, since three payment-receiving terminal devices exist, thus the CKD function calculation would generate 3 payment-receiving child keys. Similarly, to the Ethereum and Litecoin, the corresponding CKD function calculations would generate the other 3 payment-receiving child keys for each of the Ethereum and the Litecoin.

According to this invention, the CKD function calculation is a hierarchical deterministic technique meeting the BIP-32/BIP-44 standard. By performing the CKD function calculation once upon the master seed key, a plurality of child keys (i.e., first-generation child keys) can be derived. Further, by performing one more CKD function calculation upon each of the child keys, then a plurality of grandson keys (i.e., second-generation child keys) can be obtained. Furthermore, by performing further one more CKD function calculation upon each of the grandson keys, a plurality of great grandson keys (i.e., third-generation child keys) would be derived. Similarly, the aforesaid operation can be performed further to obtain more generations of child keys. According to the present invention, the CKD function calculation is featured in one-way derivation and hierarchical confirmation. In other words, through the hierarchical deterministic technique, the child keys can be derived from the master seed keys, and no master seed key can be derived from any of the child keys. In this embodiment, the first-generation child key is the aforesaid management-end child key, and the second-generation child key is the aforesaid payment-receiving child key.

The cloud management sub-system 3 includes a cloud payment management server 31 and a blockchain integrator 32. The cloud payment management server 31, connected signally with the business management terminal device 2, includes a payment-receiving confirmation module 311. The blockchain integrator 32 includes L blockchain-connected nodes and a cloud API (cloud application program interface) 321 electrically connected with the L blockchain-connected nodes. In this embodiment, the blockchain integrator 32 includes a BTC blockchain-connected node 322, an ETH blockchain-connected node 323 and a LTC blockchain-connected node 324, and these three blockchain-connected nodes are all electrically connected with the cloud API 321. The BTC blockchain-connected node 322, the ETH blockchain-connected node 323 and the LTC blockchain-connected node 324 are connected with the BTC blockchain 200a, the ETH blockchain 200b and the LTC blockchain 200c, respectively.

The payment-receiving terminal devices 4a, 4b and 4c can be disposed at the same business site or different business sites of the business, and the payment-receiving terminal devices 4a, 4b and 4c can be connected signally with the business management terminal device 2. Each of the payment-receiving terminal devices has a device ID code, and can receive one of the aforesaid M payment-receiving child keys corresponding to each of the cryptocurrencies from the cloud management module. Namely, each of the payment-receiving terminal devices 4a, 4b and 4c corresponding to Bitcoin, Ethereum and Litecoin, respectively, would receive three payment-receiving child keys from the business management terminal device 2.

In addition, each of the payment-receiving terminal devices has a barcode generator and a barcode display electrically connected with the barcode generator. In this embodiment, the payment-receiving terminal device 4a has a barcode generator 41a and a barcode display 42a electrically connected with the barcode generator 41a; the payment-receiving terminal device 4b has a barcode generator 41b and a barcode display 42b electrically connected with the barcode generator 41b; and, the payment-receiving terminal device 4c has a barcode generator 41c and a barcode display 42c electrically connected with the barcode generator 41c.

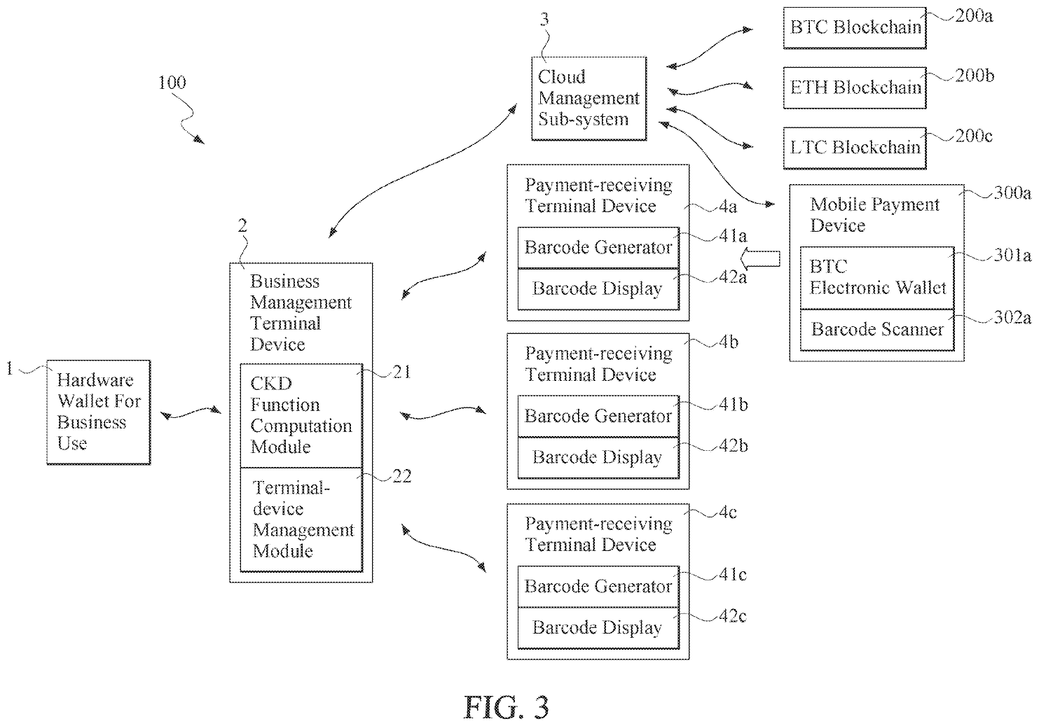

Referring to FIG. 3, a schematic functional block view showing a first usage scenario of the preferred embodiment of FIG. 1 is shown. Also, referring to FIG. 2, in the first usage scenario of the preferred embodiment, a client having a mobile payment device 300a conducts a consumption at the business site of the business through a payment-receiving terminal device 4a at a checkout counter of the business site. Here, the mobile payment device 300a, having a BTC electronic wallet 301a and a barcode scanner 302a, can be a mobile phone, a tablet computer, or any other mobile electronic communication device.

Since the mobile payment device 300a has a BTC electronic wallet 301a, thus the client can pay by Bitcoin. As such, the payment-receiving terminal device 4a can judge the kind of the cryptocurrencies (i.e., the Bitcoin) provided by the client to determine the corresponding payment-receiving child key and the device ID code of the payment-receiving terminal device 4a, and then the barcode generator 41a would generate a payment barcode accordingly to be then displayed on the barcode display 42a.

After the payment barcode is shown on the barcode display 42a, the client can utilize the barcode scanner 302a of the mobile payment device 300a to scan the payment barcode shown on the barcode display 42a. As long as the payment barcode has been scanned, the mobile payment device 300a would connect signally with the cloud payment management server 31 of the cloud management sub-system 3 to have the cloud payment management server 31 to transmit a payment-request signal. After the payment-request signal is received, the blockchain integrator 32 would connect the BTC blockchain 200a, via the cloud API 321 and the BTC blockchain-connected node 322, to pay the corresponding Bitcoin to the Bitcoin account address registered at the BTC blockchain 200a for the business, and also the BTC blockchain 200a would complete a corresponding sale-payment record.

After the sale-payment record is done, the blockchain integrator 32 would further transmit a sale-confirmed signal back to the cloud payment management server 31. Simultaneously, while the client completes the payment transaction, the business also complete the payment-collected sale. After the payment-collected sale is done, the payment-receiving confirmation module 311 would connect signally with the terminal-device management module 22 of the business management terminal device 2 so as to forward a payment-receiving confirmed signal to the business management terminal device 2, such that the user (or operator) of the business management terminal device 2 can confirm the payment-collected sale. In this embodiment, the payment-receiving confirmed signal can be realized by the terminal-device management module 22 to show the device ID code of the payment-receiving terminal device 4a, who collects the Bitcoin, and a corresponding payment-receiving amount. From which, the payment-receiving amount of the Bitcoin collected by the payment-receiving terminal device 4a can be determined and also recorded for later liquidation, statistics and analysis. Preferably, the business management terminal device 2 can further forward the payment-receiving confirmed signal to the payment-receiving terminal device 4a, and so the user (or operator) of the payment-receiving terminal device 4a can confirm the payment-collected sale.

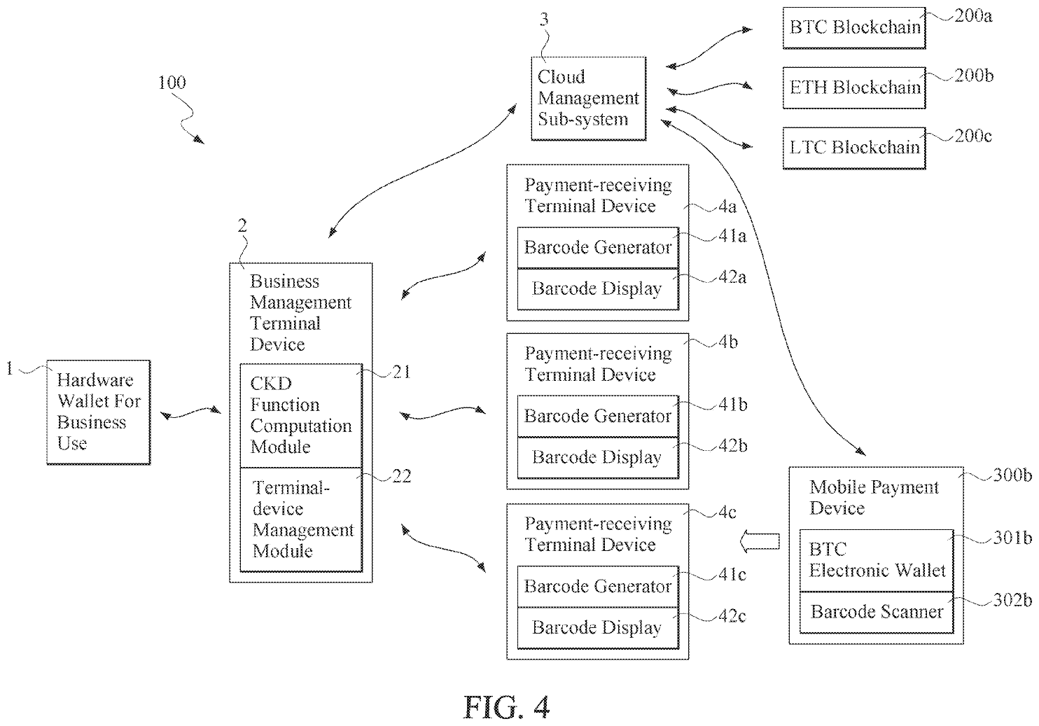

Referring to FIG. 4, a schematic functional block view showing a second usage scenario of the preferred embodiment of FIG. 1 is shown. Also, referring to FIG. 2, in the second usage scenario of the preferred embodiment, another client having a mobile payment device 300b conducts a consumption at the business site of the business through a payment-receiving terminal device 4c at a checkout counter of the business site. Here, the mobile payment device 300b, having an ETH electronic wallet 301b and a barcode scanner 302b, can be a mobile phone, a tablet computer, or any other mobile electronic communication device.

Since the mobile payment device 300b has an ETH electronic wallet 301b, thus the client can pay by Ethereum. As such, the payment-receiving terminal device 4c can judge the kind of the cryptocurrencies (i.e., the Ethereum) provided by the client to determine the corresponding payment-receiving child key and the device ID code of the payment-receiving terminal device 4c, and then the barcode generator 41c would generate a payment barcode accordingly to be then displayed on the barcode display 42c.

After the payment barcode is shown on the barcode display 42c, the client can utilize the barcode scanner 302b of the mobile payment device 300b to scan the payment barcode shown on the barcode display 42c. As long as the payment barcode has been scanned, the mobile payment device 300b would connect signally with the cloud payment management server 31 of the cloud management sub-system 3 to have the cloud payment management server 31 to transmit a payment-request signal. After the payment-request signal is received, the blockchain integrator 32 would connect the ETH blockchain 200b, via the cloud API 321 and the ETH blockchain-connected node 323, to pay the corresponding Ethereum to the Ethereum account address registered at the ETH blockchain 200b for the business, and also the ETH blockchain 200b would complete a corresponding sale-payment record.

After the sale-payment record is done, the blockchain integrator 32 would further transmit a sale-confirmed signal back to the cloud payment management server 31. Simultaneously, while the client completes the payment transaction, the business also complete the payment-collected sale. After the payment-collected sale is done, the payment-receiving confirmation module 311 would connect signally with the terminal-device management module 22 of the business management terminal device 2 so as to forward a payment-receiving confirmed signal to the business management terminal device 2, such that the user (or operator) of the business management terminal device 2 can confirm the payment-collected sale. In this embodiment, the payment-receiving confirmed signal can be realized by the terminal-device management module 22 to show the device ID code of the payment-receiving terminal device 4a, who collects the Bitcoin, and a corresponding payment-receiving amount. From which, the payment-receiving amount of the Bitcoin collected by the payment-receiving terminal device 4c can be determined and also recorded for later liquidation, statistics and analysis. Preferably, the business management terminal device 2 can further forward the payment-receiving confirmed signal to the payment-receiving terminal device 4c, and so the user (or operator) of the payment-receiving terminal device 4c can confirm the payment-collected sale.

In summary, in the cryptocurrency management system for business use 100 provided by this invention, the CKD function calculation of the hierarchical deterministic technique, the cloud management technique and the discrete blockchain record technique are integrated. Through the one-way deduction of decryption characteristics in the CKD function calculation of the hierarchical deterministic technique, collection of different cryptocurrencies (such as Bitcoin, Ethereum and Litecoin) can be feasible, and thus the security of decryption and the diversity of payment kinds can be effectively obtained. Through recording the transactions discretely to respective cryptocurrency blockchains (such as the BTC blockchain 200a, the ETH blockchain 200b and the LTC blockchain 200c), then the possibility of data tampering would be significantly reduced, and thus the clarity of transaction records can be greatly improved. In addition, through the cloud management technique to record the device ID codes and the corresponding payment-receiving amounts at the payment-receiving terminal devices 4a˜4c, the convenience in business income liquidation and management statistics can be obtained. Obviously, with this invention, the security of decryption can be upgraded, the diversity of payment kinds can be further expanded, the clarity of transaction records can be improved, and the convenience of business income liquidation and management statistics can be obtained. Namely, this invention has proved to provide remarkable improvements in different manifolds.

While the present invention has been particularly shown and described with reference to a preferred embodiment, it will be understood by those skilled in the art that various changes in form and detail may be without departing from the spirit and scope of the present invention.

What is claimed is:

1. A cryptocurrency management system, applied for business use, configured for a business to manage L kinds of cryptocurrencies, and also for a client to utilize a mobile payment device to pay by at least one of the L kinds of cryptocurrencies while consuming in at least one business site of the business, the mobile payment device having an electronic wallet with at least one of the L kinds of cryptocurrencies, the cryptocurrency management system for business use comprising:
a hardware wallet for business use, storing a master seed key;
a business management terminal device, connected signally with the hardware wallet for business use via a short-range communication means, configured to receive the master seed key, to further perform a CKD (Child key derivation) function calculation according to the master seed key for deriving L different management-end child keys to realize cryptocurrency account addresses for the L different management-end child keys corresponding to the L kinds of cryptocurrencies, and to perform the CKD function calculation for generating L×M different payment-receiving child keys according to each of the L different management-end child keys, wherein each of the L kinds of cryptocurrencies has M different payment-receiving child keys;
a cloud management sub-system, connected signally with the business management terminal device, also connected signally with L cryptocurrency blockchains corresponding to the L kinds of cryptocurrencies; and
M payment-receiving terminal devices, disposed at the at least one business site, connected signally with the business management terminal device, each of the M payment-receiving terminal devices having a device ID code, each of the M payment-receiving terminal devices receiving one of the M payment-receiving child keys corresponding to each of the L kinds of cryptocurrencies from the business management terminal device so as totally to receive L of the M payment-receiving child keys corresponding to the L kinds of cryptocurrencies, based on the device ID code and the payment-receiving child key corresponding to the cryptocurrency to be paid out of the L kinds of the cryptocurrencies while the client consumes to generate a payment barcode for the mobile payment device to scan with respect to the device ID code and the cryptocurrency to be paid;
wherein, after the client utilizes the mobile payment device to scan the payment barcode, the cloud management sub-system is connected with the cryptocurrency blockchain corresponding to the cryptocurrency to be paid of the client, and then the cryptocurrency to be paid is paid to the cryptocurrency account address corresponding to the cryptocurrency to be paid;
wherein the cloud management sub-system includes a cloud payment management server and a blockchain integrator, and is connected signally with the mobile payment device and the business management terminal device;
wherein, after the client utilizes the mobile payment device to scan the payment barcode, the cloud management sub-system transmits a payment-request signal;
wherein, upon receiving the payment-request signal, the blockchain integrator connected signally with the cloud payment management server connects the cryptocurrency blockchain corresponding to the cryptocurrency to be paid of the client;
wherein, after the cryptocurrency blockchain completes a sale-payment record, a sale-confirmed signal is transmitted back to the cloud payment management server.

2. The cryptocurrency management system of claim 1, wherein the blockchain integrator includes:
L blockchain-connected nodes, configured to connect individually the L cryptocurrency blockchains; and
a cloud API, electrically connected with the L blockchain-connected nodes, transmitting the sale-confirmed signal upon when the sale-payment record is complete.

3. The cryptocurrency management system of claim 2, wherein the cloud payment management server further includes a payment-receiving confirmation module connected signally with the cloud API, and the payment-receiving confirmation module transmits a payment-receiving confirmed signal to the business management terminal device after the sale-confirmed signal is received.

4. The cryptocurrency management system of claim 3, wherein the business management terminal device further includes a terminal-device management module connected signally with the payment-receiving confirmation module and the M payment-receiving terminal devices, the terminal-device management module is configured to transmit the payment-receiving confirmed signal to the payment-receiving terminal device corresponding to the device ID code, and to record the device ID code and a corresponding payment-receiving amount of the payment-receiving terminal device with respect to the cryptocurrency to be paid.

5. The cryptocurrency management system of claim 1, wherein the business management terminal device includes a CKD function computation module configured for performing the CKD function calculation to derive the L different management-end child keys for realizing the L cryptocurrency account addresses.

6. The cryptocurrency management system of claim 1, wherein the short-range communication means is one of a Bluetooth communication means and a near-field communication (NFC) means.

7. The cryptocurrency management system of claim 1, wherein each of the M payment-receiving terminal devices further includes:
a barcode generator, configured for generating the payment barcode; and
a barcode display, electrically connected with the barcode generator, configured for displaying the payment barcode.
